(19) United States
(12) Patent Application Publication
(10) Pub. No.: US 2019/0091628 A1
(43) Pub. Date: Mar. 28, 2019

(54) EXHAUST GAS FILTER

(71) Applicant: DENSO CORPORATION, Kariya-city, Aichi-pref. (JP)

(72) Inventors: Yasushi TAKAYAMA, Kariya-city, Aichi-pref. (JP); Yoichi KADOTA, Kariya-city, Aichi-pref. (JP)

(21) Appl. No.: 16/065,367

(22) PCT Filed: Nov. 16, 2016
(86) PCT No.: PCT/JP2016/083879

§ 371 Date: Jun. 22, 2018

(30) Foreign Application Priority Data
Dec. 25, 2015 (JP) 2015-254097

(51) Int. Cl. B01D 53/94; B01D 46/24; B01J 23/63; B01J 35/04; F01N 3/022; F01N 3/035

(52) U.S. Cl. CPC B01D 53/945; B01D 46/2429; B01J 23/63; B01J 35/04; F01N 3/0222; F01N 3/101; B01D 2255/1023; B01D 2255/908; B01D 2255/9155; B01D 2279/30; F01N 3/035

(57) ABSTRACT

Provided is an exhaust gas filter comprising a plurality of cell walls, a plurality of cell holes surrounded by the cell walls, and plug parts each sealing one of both ends of at least a part of the cell holes. The cell walls each have pores that allow adjacent cell holes to communicate with each other. The cell walls contain at least one promoter selected from the group consisting of ceria, zirconia, and a ceria-zirconia solid solution as a constituent thereof.

### TECHNICAL FIELD

The present invention relates to an exhaust gas filter for purifying exhaust gas of an internal combustion engine.

### BACKGROUND ART

An exhaust pipe of an internal combustion engine is provided with an exhaust gas purification device for trapping particulate matter (i.e., PM) contained in exhaust gas. The exhaust gas purification device is provided with an exhaust gas filter including, for example, cordierite, for trapping PM contained in the exhaust gas (see PTL 1). In order to purify toxic substances contained in the exhaust gas, the exhaust gas filter is coated with a noble metal catalyst and a promoter having oxygen storage capacity (i.e., OSC). The toxic substances include hydrocarbons, carbon monoxide, nitrogen oxides, and the like. The promoter is composed of a ceria-zirconia solid solution, etc.

### CITATION LIST

### Patent Literature

[PTL 1] JP 2013-530332 A

### SUMMARY OF THE INVENTION

### Technical Problem

However, when the exhaust gas filter is coated with a promoter, pores in cell walls may be closed by the promoter. This may lead to an increase in the pressure loss of the exhaust gas filter. For this reason, there is a limitation on the amount of the promoter that can be coated on the cell walls, and the oxygen storage capacity cannot be sufficiently increased. Moreover, when a promoter is coated, the weight of the exhaust gas filter increases, and the heat capacity thus increases. Consequently, the temperature increase performance decreases, thereby making the early activation of the exhaust gas filter difficult.

The present invention has been achieved in view of the above problems, and provides an exhaust gas filter having good oxygen storage capacity and temperature increase performance.

### Solution to Problem

One embodiment of the present invention is an exhaust gas filter (1) includes: a plurality of cell walls (2), a plurality of cell holes (3) surrounded by the cell walls, and plug parts (4) each sealing one of both ends of at least a part of the cell holes, in which the cell walls each have pores (20) that allows adjacent cell holes to communicate with each other, and the cell walls contain at least one promoter (21) selected from the group consisting of ceria, zirconia, and a ceria-zirconia solid solution, as a constituent of the cell walls.

The numerals in parentheses are assigned for reference, and are not intended to limit the invention.

### Advantageous Effects of the Invention

In the aforementioned exhaust gas filter, the cell walls have pores, and the cell walls themselves are composed of a promoter as a constituent, as described above. Accordingly, it is not necessary to separately coat the exhaust gas filter with a promoter. Therefore, an increase in the weight of the exhaust gas filter can be prevented, and an increase in the heat capacity can also be prevented. Consequently, the exhaust gas filter exhibits good temperature increase performance, making the early activation of the exhaust gas filter possible. Moreover, since it is not necessary to coat the exhaust gas filter with a promoter, there is no need to limit the amount of the promoter in order to prevent an increase in pressure loss. Accordingly, the promoter can sufficiently exhibit oxygen storage capacity, while preventing an increase in pressure loss. Therefore, the exhaust gas filter can exhibit good purification performance for exhaust gas.

Furthermore, the cell walls have pores, and the exhaust gas can pass through the pores in the cell walls. Accordingly, particulate matter (hereinafter referred to as “PM”) contained in the exhaust gas can be trapped in the cell walls. In addition, toxic components, such as hydrocarbons, carbon monoxide, and nitrogen oxides, contained in the exhaust gas can be sufficiently purified by the promoter contained in the cell walls. Further, the cell walls themselves have catalytic performance. Accordingly, even if not all the exhaust gas passes through the cell walls, a flow passing through the cell walls is formed as long as part of the exhaust gas passes through the cell walls; thus, good exhaust gas purification performance can be exhibited. Therefore, the exhaust gas filter can reduce PM emission and purify the exhaust gas, since the exhaust gas can pass through the cell walls, and the cell walls themselves can exhibit catalytic performance, as described above.

As described above, the aforementioned embodiment can provide an exhaust gas filter having good oxygen storage capacity and temperature increase performance.

### BRIEF DESCRIPTION OF THE DRAWINGS

FIG. 1 is a perspective view of an exhaust gas filter according to Embodiment 1.

FIG. 2 is a partial enlarged view of an upstream end surface of the exhaust gas filter according to Embodiment 1, facing the exhaust gas flow.

FIG. 3 is an axial cross-sectional view of the exhaust gas filter according to Embodiment 1.

FIG. 4 is an enlarged cross-sectional view of the cell wall according to Embodiment 1.

FIG. 5 is a partial enlarged view of an upstream end surface of an exhaust gas filter according to Embodiment 2, facing the exhaust gas flow.

FIG. 6 is an axial cross-sectional view of the exhaust gas filter according to Embodiment 2.

FIG. 7 is a partial enlarged view of an upstream end surface of an exhaust gas filter according to Embodiment 3, facing the exhaust gas flow.

FIG. 8 is an axial cross-sectional view of the exhaust gas filter according to Embodiment 3.

FIG. 9 is a partial enlarged view of an upstream end surface of an exhaust gas filter of a modified example according to Embodiment 3, facing the exhaust gas flow.

FIG. 10 is an explanatory diagram showing the temperature changes with time of each exhaust gas filter in an Experimental Example.

### DESCRIPTION OF THE EMBODIMENTS

### Embodiment 1

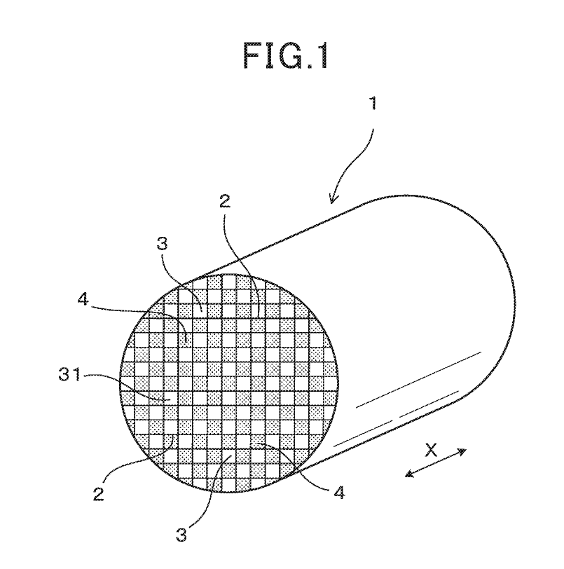

An embodiment of the exhaust gas filter will be described with reference to FIGS. 1 to 4. As shown in FIGS. 1 to 3, the exhaust gas filter 1 of the present embodiment has many cell walls 2 and many cell holes 3. The cell holes 3 are formed by being surrounded by the cell walls 2. The exhaust gas filter 1 further has plug parts 4 each sealing one of both ends 31 and 32 of each cell hole 3.

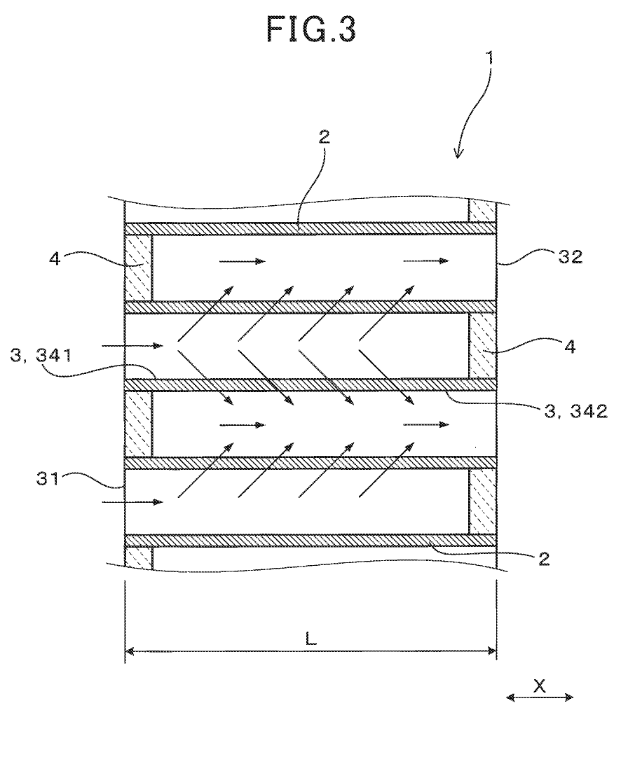

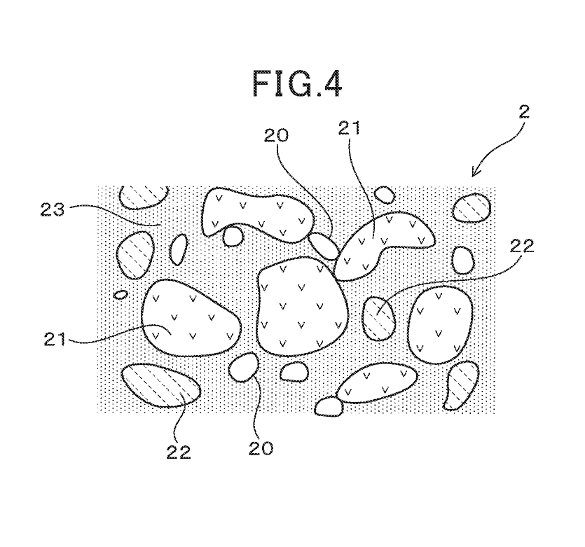

As shown in FIGS. 3 and 4, the cell walls 2 are provided with pores 20 that allow adjacent cell holes 3 to communicate with each other. The cell walls 2 contain, as a constituent thereof, a promoter 21 composed of a ceria-zirconia solid solution. This is described in further detail below.

As shown in FIGS. 1 to 3, the exhaust gas filter 1 is formed in, for example, a cylindrical shape, and the exhaust gas filter 1 has cell walls 2 and many cell holes 3 inside thereof. The cell walls 2 are provided in a lattice shape. The many cell holes 3 are surrounded by the cell walls 2 and extend in an axial direction X. The shape of the exhaust gas filter 1 may be cylindrical, as in the present embodiment; however, the shape of the exhaust gas filter 1 may also be a polygonal column, such as a square column. Moreover, the cell walls 2 can be formed so that the inner peripheral shape of the cell holes 3 is a tetragon, such as a square, as in the present embodiment. The inner peripheral shape of the cell holes 3 is on a cross-section in the radial direction of the exhaust gas filter 1 (that is, a cross-section perpendicular to the axial direction X). The thickness of the cell walls 2 and the number of the cell holes 3 can be suitably adjusted, depending on the required characteristics, such as strength and pressure loss.

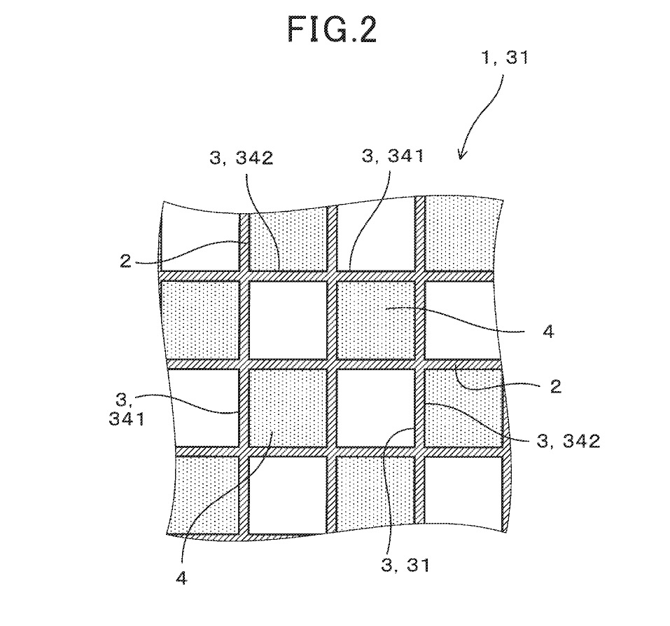

As shown in FIG. 2, the inner peripheral shape of the cell holes 3 is, for example, a square. The square cell holes 3 are arranged at equal intervals in a longitudinal direction parallel to one side of the square, and in a transverse direction orthogonal to the longitudinal direction. Alternatively, the cell walls 2 may be formed so that the inner peripheral shape of the cell holes 3 is a polygon, such as a triangle, hexagon, octagon, or dodecagon. The inner peripheral shape of the cell holes 3 is on a cross-section in the radial direction of the exhaust gas filter 1. Further, the inner peripheral shape of the cell holes 3 may be a circle. Moreover, the cell holes 3 may have an uniform inner peripheral shape, as shown in FIG. 2. However, the many cell holes 3 may include two or more types of cell holes 3 having different inner peripheral shapes, as shown in Embodiments 3 and 4, provided later. Furthermore, even if the cell holes 3 have similar shapes and different sizes, the inner peripheral shapes of the cell holes 3 are different.

As shown in FIG. 4, the cell walls 2 contain a promoter 21 composed of a ceria-zirconia solid solution, and also contain an aggregate 22 composed of θ alumina, and an inorganic binder 23. The promoter 21 is, for example, a ceria-zirconia solid solution in which zirconium is dissolved in ceria; however, ceria and zirconia can also be used. That is, the promoter 21 to be used can be at least one member selected from the group consisting of ceria, zirconia, and a ceria-zirconia solid solution. Moreover, when a ceria-zirconia solid solution is used, La or Y, which is a rare earth element, may be further dissolved in the solid solution, other than zirconium. Usable examples of the inorganic binder 23 include alumina, silica, zirconia, titania, and the like; alumina is preferably used.

It is preferable that the cell walls 2 are composed of a material containing a ceria-zirconia solid solution as a main component, and further containing θ alumina and an inorganic binder. In this case, the cell walls 2 of the exhaust gas filter 1 can exhibit more good catalytic performance. In the cell walls 2, the inorganic binder 23 forms a matrix. The promoter 21 composed of ceria-zirconia, and the aggregate 22 composed of θ alumina are dispersed in the matrix. This can be confirmed, for example, by a scanning electron microscope (i.e., SEM). Further, pores 20 are formed, for example, between the promoters 21, between the aggregates 22, between the promoter 21 and the aggregate 22, between the promoter 21 and the inorganic binder 23, and between the aggregate 22 and the inorganic binder 23. These pores 20 allow the cell holes 3 adjacent to each other through the cell walls 2 to communicate with each other, and the cell walls 2 are made of porous materials. In the cell walls 2, the content of the promoter 21 based on 100 parts by mass of the total amount of the promoter 21 and the aggregate 22 can be set to, for example, an amount greater than 50 parts by mass.

Moreover, although the illustration is omitted, the cell walls 2 of the exhaust gas filter 1 may carry a noble metal catalyst. For the noble metal catalyst, at least one noble metal selected from Pt, Pd, Rh, etc., can be used. The noble metal catalyst functions as “three-way catalyst”, and purifies exhaust gas by oxidation or reduction of hydrocarbons, carbon monoxide, nitrogen oxides, etc.

As shown in FIGS. 1 to 3, each cell hole 3 has an upstream end 31 facing the exhaust gas flow in the cell hole 3, and a downstream end 32 opposite to the upstream end 31. One of the upstream end 31 and the downstream end 32 is sealed with a plug part 4. The plug parts 4 alternately seal the upstream ends 31 or the downstream ends 32 of the adjacent cell holes 3. The cell holes 3 each of the exhaust gas filter 1 are composed of a corresponding cell hole 3A and cell hole 3B. The cell holes 3A have respective upstream open cell holes 341 in which the upstream ends 31 of the cell holes 3 open. The cell holes 3B have respective downstream open cell holes 342 in which the downstream ends 32 of the cell holes 3 open. The cell holes 3A and the cell holes 3B are alternately arranged. Note that the present embodiment shows an example of the pattern of formation of the plug parts 4, and the pattern of formation of the plug parts 4 is not limited to the present embodiment.

Next, the method for producing the exhaust gas filter 1 according to the present embodiment will be described. First, a promoter composed of a ceria-zirconia solid solution, an aggregate made of alumina, an inorganic binder raw material, and a pore-forming material are mixed. Examples of the inorganic binder raw material include sols of various inorganic binders, such as alumina sol and silica sol. Examples of the pore-forming material include organic materials, carbon, and the like that disappears during firing, which will be described later. The amount of the promoter mixed can be adjusted, for example, to an amount greater than 50 parts by mass based on 100 parts by mass of the total amount of the promoter and the aggregate.

Then, an organic binder, a molding assistant, water, etc., are added to the mixture and kneaded to obtain a green body. The green body is then molded into a honeycomb structure to obtain a molded body. Thereafter, the molded body is dried and fired, thereby obtaining an exhaust gas filter with a honeycomb structure. The exhaust gas filter with a honeycomb structure has many cells, and both ends of each cell open. The firing temperature is, for example, 700 to 1200° C., and the firing time is, for example, 2 to 50 hours.

Subsequently, plug parts 4 are formed in the exhaust gas filter in which both ends of the cells open. Specifically, a ceria-zirconia solid solution, water, an organic binder, etc., are first mixed to produce a clay-like plug part-forming material. Then, one of both ends of each cell hole is closed by the plug part-forming material. Subsequently, the plug part-forming material is fired in an electric furnace to form plug parts each closing one of both ends of the cell holes. The formation of the plug parts can be performed before the firing of the honeycomb structure, or the firing of the honeycomb structure and the firing of the plug parts may be performed at the same time. Moreover, the pattern of formation of the plug part-forming material can be suitably changed, and the plug parts can be formed in a desired pattern.

Thereafter, the exhaust gas filter obtained in the above manner can be allowed to carry a noble metal catalyst by a conventional method, for example. Specifically, for example, the exhaust gas filter is first immersed in an aqueous solution containing a noble metal salt. After the aqueous solution containing a noble metal salt is impregnated in the exhaust gas filter, the exhaust gas filter is dried. A repetition of the impregnation and drying process allows the exhaust gas filter to carry a desired amount of the noble metal salt. The exhaust gas filter is then heated, thereby obtaining an exhaust gas filter carrying a noble metal catalyst.

Next, the working effects of the exhaust gas filter 1 of the present embodiment are described. The exhaust gas filter 1 is used in such a manner that it is placed in an exhaust gas flow passage in order to purify exhaust gas generated in an internal combustion engine. Examples of internal combustion engines include diesel engines, gasoline engines, and the like. As shown in FIGS. 1 to 4, the cell walls 2 of the exhaust gas filter 1 have pores 20 that allow the adjacent cell holes 3 to communicate with each other. Accordingly, the exhaust gas introduced into the cell holes 3 can pass through the cell walls 2 through the pores 20.

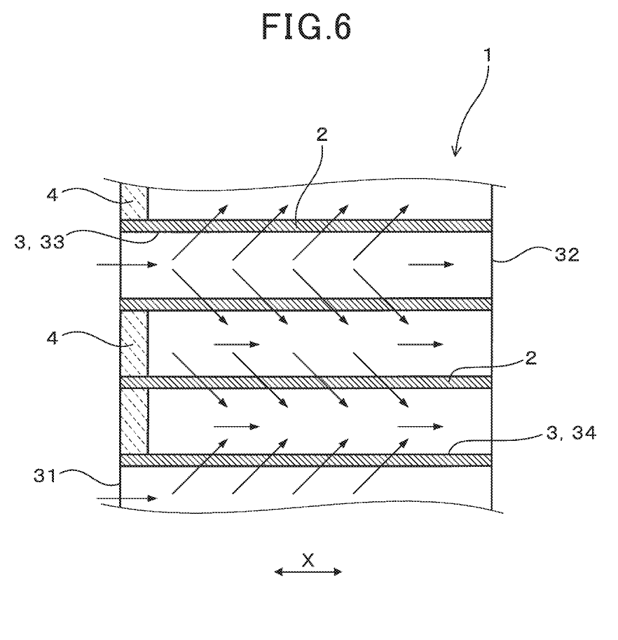

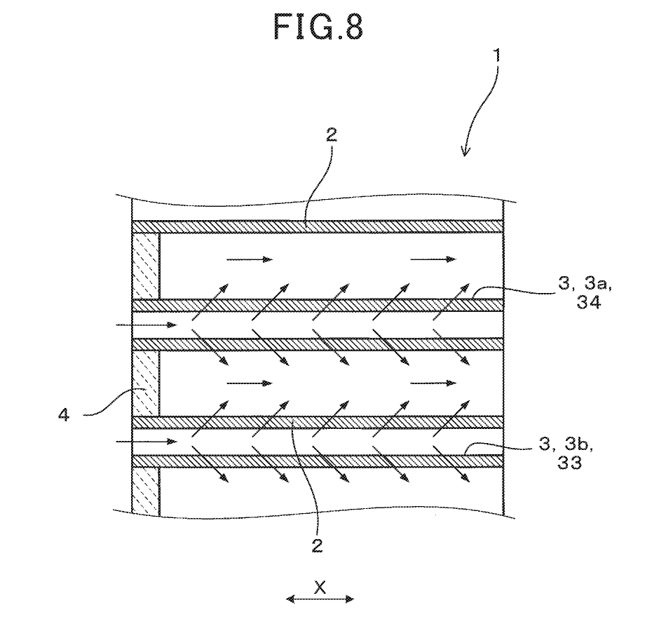

In the exhaust gas filter 1 of the present embodiment, one of both ends 31 and 32 of the cell holes 3 is sealed with the plug part 4. The plug parts 4 alternately seal the upstream ends 31 or the downstream ends 32 of the adjacent cell holes 3. Therefore, a flow of the exhaust gas is easily formed; more specifically, the exhaust gas introduced into the upstream open cell holes 341 passes through the cell walls 2 and is discharged from the downstream open cell holes 342. That is, the exhaust gas can easily pass through the cell walls 2. Therefore, PM contained in the exhaust gas is easily trapped in the cell walls 2, and the catalyst contained in the cell walls 2 frequently contacts the exhaust gas. Accordingly, the exhaust gas filter 1 exhibits good exhaust gas purification performance, and can sufficiently purify the exhaust gas. The arrows in FIG. 3 represent the main flow of exhaust gas in the exhaust gas filter 1, and the same applies to FIGS. 6 and 8, provided later.

In the exhaust gas filter 1, the cell walls 2 themselves include the promoter 21 as a constituent, as shown in FIG. 4. It is thus not necessary to separately coat the exhaust gas filter 1 with the promoter. Therefore, an increase in the weight of the exhaust gas filter can be prevented, and an increase in heat capacity can also be prevented. Consequently, the exhaust gas filter 1 exhibits good temperature increase performance, making the early activation thereof possible.

Thus, the exhaust gas filter 1 allows the exhaust gas to pass through the inside of the cell walls 2, and the cell walls 2 themselves can exhibit catalytic performance. Accordingly, the exhaust gas filter 1 can reduce PM emission and purify the exhaust gas.

It is not necessary to separately coat the exhaust gas filter 1 with the promoter 21, as described above. Thus, there is no need to limit the amount of the promoter 21 in order to prevent an increase in pressure loss. Accordingly, in the exhaust gas filter 1, the oxygen storage capacity of the promoter 21 in the cell walls 2 can be sufficiently exhibited, while preventing an increase in pressure loss. Therefore, the exhaust gas filter 1 can show good oxygen storage capacity and exhibit good purification performance for the exhaust gas.

In the exhaust gas filter 1, it is preferable that the plug parts 4 contain the promoter 21 as a constituent thereof. In this case, the promoter 21 contained not only in the cell walls 2, but also in the plug parts 4, can be used to purify the exhaust gas. Moreover, because the coefficient of thermal expansion of the cell walls 2 can be brought close to that of the plug parts 4, the occurrence of cracks, etc., can be prevented.

As described above, the present embodiment can provide the exhaust gas filter 1 that has excellent oxygen storage capacity and temperature increase performance.

### Embodiment 2

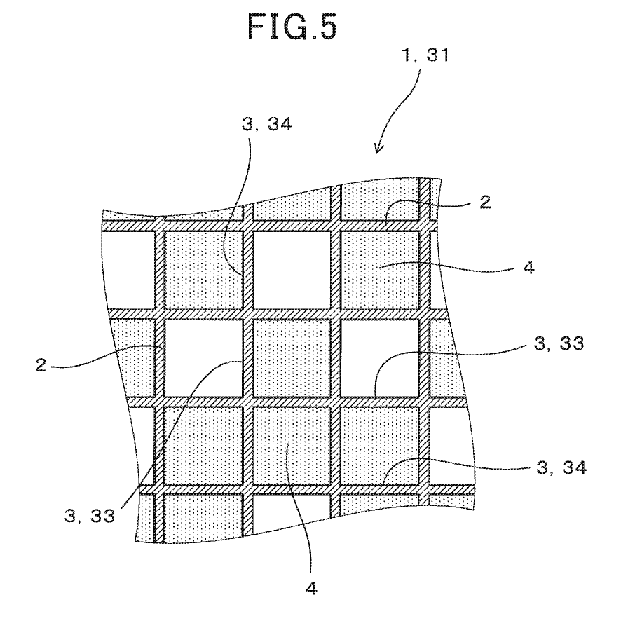

Next, an embodiment of an exhaust gas filter that has open cell holes penetrating the exhaust gas filter in the axial direction will be described. As shown in FIGS. 5 and 6, the cell holes 3 in the present embodiment are made up of open cell holes 33 and plugged cell holes 34. The open cell holes 33 are cell holes penetrating the exhaust gas filter 1 in the axial direction X. The plugged cell holes 34 are cell holes provided with respective plug parts 4 closing upstream ends 31 of the exhaust gas filter 1 facing the exhaust gas flow. The plug parts 4 are respectively disposed in the upstream ends 31 of the cell holes 3. No plug parts 4 are provided in downstream ends 32 of all the cell holes 3 opposite to the upstream ends 31, and the downstream ends 32 of the cell holes 3 open.

In the present embodiment, as shown in FIG. 5, three cell holes 3 arranged in longitudinal and transverse directions (nine cell holes 3 in total) are regarded as one section, and the sections are suitably spread to form the exhaust gas filter 1. Of the nine cell holes 3 in one section, three cell holes 3 that are not adjacent to each other are regarded as the open cell holes 31, and the other cell holes 3 are regarded as the plugged cell holes 32. Other structures are the same as those of Embodiment 1. Among the numerals used in Embodiments 2 and 3, those same as the numerals used in the previous embodiment indicate the same constituents, etc., as those in the previous embodiment, unless otherwise specified.

Part of the exhaust gas introduced into the open cell holes 33 passes through the pores of the cell walls 2 and is discharged from the plugged cell holes 34. In this case, PM contained in the exhaust gas can be trapped in the cell walls 2. Moreover, the promoter contained in the cell walls 2 can sufficiently exhibit good oxygen storage capacity to purify the exhaust gas. Since the cell walls 2 themselves show catalytic performance, it is not necessary for all the exhaust gas to pass through the cell walls. Due to the formation of a flow of the exhaust gas passing through the cell walls, exhaust gas purification performance can be exhibited. Furthermore, due to the presence of the open cell holes 33, an increase in the pressure loss of the exhaust gas filter 1 can be sufficiently prevented.

Moreover, the cell holes 3 have the open cell holes 33, and the plug parts 4 are respectively disposed in the upstream ends 31 of the plugged cell holes 34. Accordingly, ash including calcium compounds, etc., contained in the exhaust gas together with PM can be discharged from the exhaust gas filter 1. Ash cannot be removed by combustion. Therefore, for example, in an exhaust gas filter provided with plug parts disposed in respective downstream ends 32 of plugged cell holes, ash remains and accumulates in the inside of the filter. In contrast, in the exhaust gas filter 1 of the present embodiment, the exhaust gas is separated by the cell walls 2 when passing through the cell walls 2, and ash remains in the open cell holes 33. Since the open cell holes 33 penetrate the exhaust gas filter 1 in the axial direction X, the ash can be easily discharged from the open cell holes 33, and the ash can be prevented from remaining in the exhaust gas filter 1. This can reduce a reduction in the purification performance of the exhaust gas filter 1.

Furthermore, as shown in FIG. 5, it is preferable that, in a cross-section orthogonal to the axial direction X of the exhaust gas filter 1, the flow passage cross-sectional area of each plugged cell hole 34 is larger than the flow passage cross-sectional area of each open cell hole 33. In this case, the exhaust gas can be efficiently circulated through the pores formed in the cell walls 2. Further, PM contained in the exhaust gas can be sufficiently trapped in the cell walls 2. Moreover, the promoter 21 contained in the cell walls 2 can sufficiently exhibit good oxygen storage capacity. Consequently, the exhaust gas purification performance of the exhaust gas filter 1 can be improved. In addition, the present embodiment has the same working effects as those of Embodiment 1.

### Embodiment 3

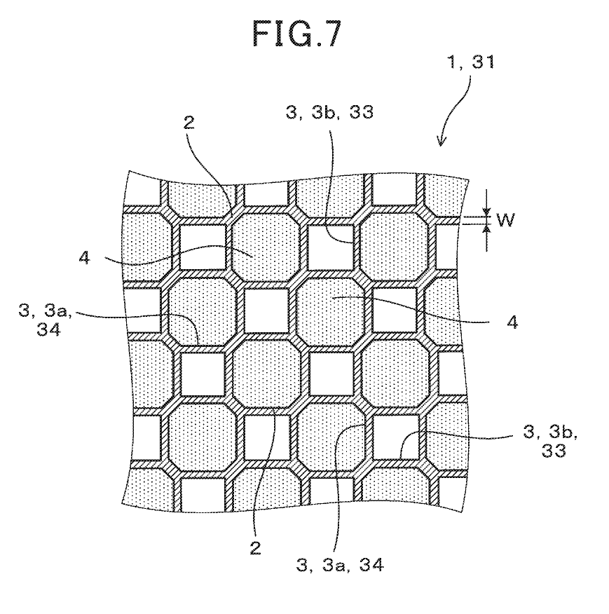

Next, an embodiment of an exhaust gas filter that has cell holes with an octagonal inner peripheral shape and cell holes with a square inner peripheral shape will be described. As shown in FIGS. 7 and 8, the exhaust gas filter 1 of the present embodiment has, as cell holes 3, cell holes 3a with an octagonal inner peripheral shape and cell holes 3b with a square inner peripheral shape. The cell holes 3 are made up of open cell holes 33 and plugged cell holes 34, as in Embodiment 2. The open cell holes 33 penetrate the exhaust gas filter 1 in the axial direction X. The plugged cell holes 34 are respectively provided with plug parts 4 closing upstream ends 31 of the exhaust gas filter 1 facing the exhaust gas flow. The plug parts 4 are respectively provided in the upstream ends 31 of the cell holes 3. No plug parts 4 are provided in downstream ends 32 of all the cell holes 3 opposite to the upstream ends 31, and the downstream ends 32 of the cell holes 3 open. Other structures are the same as those of Embodiment 1.

The hydraulic diameter of each octagonal cell hole 3a is larger than the hydraulic diameter of each square cell hole 3b. In the exhaust gas filter 1, it is preferable that the octagonal cell holes 3a and the square cell holes 3b are alternately arranged. In this case, the difference between each hydraulic diameter of the octagonal cell hole 3a and each hydraulic diameter of the square cell hole 3b can be increased. Thereby, for example, when the octagonal cell holes 3a and the square cell holes 3b are suitably allocated as plugged cell holes 34 and open cell holes 33, respectively, each plugged cell holes 34 and each open cell holes 33 can be made adjacent. This arrangement can effectively increase the pressure difference between each plugged cell hole 34 and each open cell hole 33.

By taking advantage of this pressure difference, the exhaust gas flowing into the open cell holes 33 can be efficiently circulated to the plugged cell holes 34 through the pores. Moreover, the pressure difference between each open cell hole 33 and each plugged cell hole 34 is more reduced from upstream of the exhaust gas filter 1 toward downstream. However, the circulation of the exhaust gas into the pores is continued within the range in which a pressure difference occurs between each open cell hole 33 and each plugged cell hole 34. Accordingly, the exhaust gas can pass through the cell walls 2 in a broader range of the exhaust gas filter 1 by increasing the pressure difference between each open cell hole 33 and each plugged cell hole 34, as described above. PM contained in the exhaust gas can thereby be effectively trapped.

On the other hand, when the plugged cell holes 34 are adjacent to each other, or when the open cell holes 33 are adjacent to each other, it is difficult for a pressure difference to occur between the plugged cell holes 34 or between the open cell holes 33. Accordingly, there are few useful functions in terms of trapping performance. Moreover, the cell shape is preferably a shape with a large hydraulic diameter, in terms of the pressure loss of the exhaust gas filter 1. Therefore, cell holes 3 formed in a triangular shape, etc., are likely to cause an increase in the pressure loss of the exhaust gas filter 1. From the above viewpoint, the purification performance can be efficiently improved by forming the octagonal cell holes 3a and the square cell holes 3b in an alternate arrangement. In addition, the present embodiment has the same working effects as those of Embodiment 1.

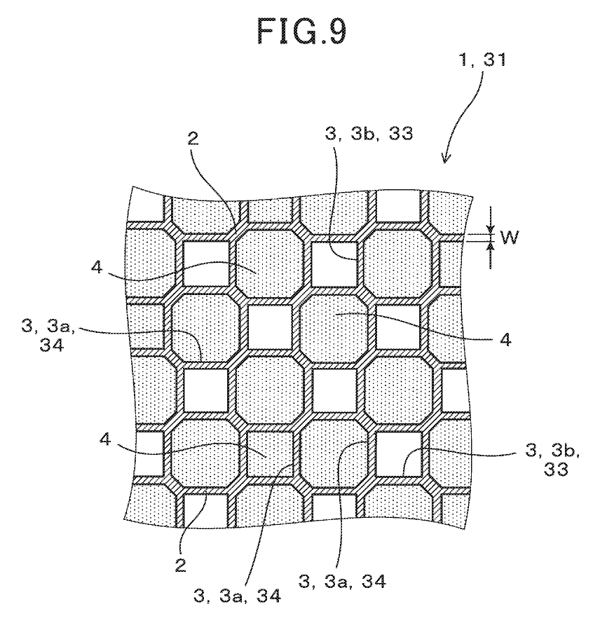

In the exhaust gas filter 1 of the present embodiment, the square cell holes 3b were used as the open cell holes 33, and the octagonal cell holes 3a were used as the plugged cell holes 34. The open cell holes 33 and the plugged cell holes 34 are formed in an alternate arrangement; however, any shapes other than this shape may be employed. For example, as shown in FIG. 9, some of the square cell holes 3b may also be used as the plugged cell holes 34. The same working effects as those of the present embodiment can also be obtained in this case.

Note that the present invention is not limited to the embodiments described above, and can be applied to various embodiments within a range that does not depart from the gist of the invention. For example, a single cylindrical exhaust gas filter is used in each of the above-mentioned embodiments; however, a joined exhaust gas filter configured of a plurality of exhaust gas filters that are joined together can also be used. Specifically, for example, a plurality of exhaust gas filters in a square columnar shape, such as a rectangular parallelepiped shape, may be produced, and the produced exhaust gas filters may be integrated by joining them on their side surfaces.

### Experimental Example

Next, the oxygen storage capacity and temperature increase performance are compared between the Example and Comparative Examples of the exhaust gas filters. In the present experimental example, 3 types of exhaust gas filters of Example 1, Comparative Example 1, and Comparative Example 2 are evaluated. The exhaust gas filters all have a cylindrical shape, a diameter Φ of 103 mm, and a length L in the axial direction of 105 mm.

The exhaust gas filter of Example 1 has the same structure as that of Embodiment 1 described above. The cell walls themselves are made up of, as a constituent, a promoter made of a ceria-zirconia solid solution, and plug parts are respectively formed at the ends of the cells. The exhaust gas filter of Example 1 has a cell wall thickness of 8 mil and a cell number of 300 meshes. The term “mil” represents the thickness of the cell wall, and its unit is 1/1000 inch. Further, the term “mesh” represents the number of cells per square inch. Moreover, the cell walls carry a noble metal catalyst (specifically Pd). The total amount of the promoter and the noble metal catalyst in the exhaust gas filter of Example 1 is 300 g/L, as shown in Table 1, provided later.

Comparative Examples 1 and 2 are exhaust gas filters composed of cordierite. Comparative Example 1 is a straight flow-type exhaust gas filter in which no plug parts are formed at both ends of the cells, and both ends of each cell open. Comparative Example 2 is an exhaust gas filter in which plug parts composed of cordierite are formed at both ends of the cells, and the pattern of formation of the plug parts is the same as that of Example 1. Moreover, the cell walls of the exhaust gas filter of Comparative Example 2 have many pores, as in Example 1, and the exhaust gas can pass through the cell walls. The cell walls of the exhaust gas filters of Comparative Examples 1 and 2 carry a promoter and a noble metal catalyst, and these catalysts are carried after the production of the exhaust gas filters. The exhaust gas filters of Comparative Examples 1 and 2 are produced, for example, by a known method. The total amount of the promoter and the noble metal catalyst is 240 g/L in Comparative Example 1 and 100 g/L in Comparative Example 2, as shown in Table 1, provided later.

### “Measurement of Oxygen Storage Capacity”

The exhaust gas filters of Example 1, Comparative Example 1, and Comparative Example 2 were each mounted in a gasoline engine exhaust system with a displacement of 2.5 liter. The temperature of the gas entering each exhaust gas filter was adjusted to about 600° C., and the air-fuel ratio A/F of the exhaust gas was adjusted to the theoretical air-fuel ratio, i.e., 14.6. In each exhaust gas filter, the side facing the exhaust gas flow is regarded as the upstream of the exhaust gas filter. The side opposite to the upstream side of the exhaust gas filter is regarded as the downstream side of the exhaust gas filter. Then, while monitoring the output of an O₂ sensor, the air-fuel ratio was switched from the theoretical air-fuel ratio to the rich condition, i.e., 14.1, and to the lean condition, i.e., 1.51. The O₂ sensor is disposed in the downstream of the exhaust gas filter in the flow direction of the exhaust gas. The oxygen storage amount of the exhaust gas filter was determined by measuring the output delay of the 02 sensor at the time of switching. Table 1 shows the results.

### “Temperature Increase Performance”

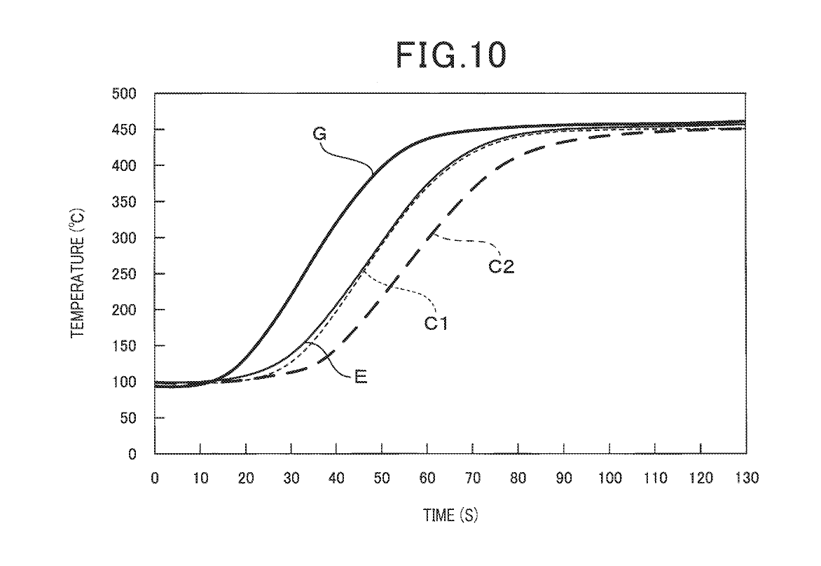

The exhaust gas filters of Example 1, Comparative Example 1, and Comparative Example 2 were each mounted in a gasoline engine exhaust system with a displacement of 2.5 liter. Each exhaust gas filter was disposed in a position apart from an engine exhaust manifold through a water-cooling pipe. The engine was driven at the theoretical air-fuel ratio, and the inlet temperature of each exhaust gas filter was adjusted to 100° C. by means of cooling water flowing through the inside of the water-cooling pipe. The term “inlet temperature” refers to the temperature of the upstream end of the exhaust gas filter in the flow direction of the exhaust gas, the upstream end facing the exhaust gas flow. Then, the flow rate of cooling water was controlled to thereby increase the inlet temperature of each exhaust gas filter, as shown in FIG. 10. In this case, the temperature of the exhaust gas filter was measured with time. In FIG. 10, the horizontal axis represents the time elapsed from the start of measurement, and the vertical axis represents the temperature of the exhaust gas filter. In FIG. 10, graph E shows the results of Example 1, graph C1 shows the results of Comparative Example 1, and graph C2 shows the results of Comparative Example 2. Moreover, graph G shows the temperature of the exhaust gas flowing into the exhaust gas filter. The same amount of heat is supplied to each exhaust gas filter.

TABLE 1

| | | | Total amount | |
|---|---|---|---|---|
| Example and | | Method for | of promoter | Oxygen |
| Comparative | Presence of | forming | and noble met- | storage |
| Example No. | plug part | promoter | al catalyst (g/L) | amount (g) |
| Example 1 | Formed | Integrated | 300 | 1.56 |
| | | with filter | | |
| Comparative | None | Coated on | 240 | 1.25 |
| Example 1 | | cell walls | | |
| Comparative | Formed | Coated on | 100 | 0.57 |
| Example 2 | | cell walls | | |

As is known from Table 1, because the filter of Example 1 itself contained a promoter as a constituent, the amount of catalyst could be increased, and a higher oxygen storage amount was shown, compared with Comparative Examples 1 and 2. Comparatively, in Comparative Examples 1 and 2, in which the produced filter was used as a substrate, and a promoter and a noble metal catalyst were carried on the substrate, there is a limitation on the amount of the promoter in order to avoid the situation in which the pores in the cell walls, which serve as the flow passage of the exhaust gas, are buried and closed by the promoter, etc. In particular, in Comparative Example 2, in which plug parts are formed at the ends of the cells, there is a tendency that pressure loss significantly increases because the catalysts are carried; thus, the limit value of the amount of the promoter carried decreases, as shown in Table 1.

Moreover, the temperature increase performance of Comparative Example 2 is low, as is known from FIG. 10. This is because the heat capacity of the exhaust gas filter of Comparative Example 2 is a large value obtained by summing the heat capacity of the promoter and the heat capacity of the substrate. The promoter is carried on the substrate in order to impart exhaust gas purification performance. The substrate is a member that impair catalytic activity and that is used to maintain the structure of the exhaust gas filter. In contrast, the exhaust gas filter of Example 1 itself comprises a promoter having exhaust gas purification performance as a constituent. It is thus not necessary for the exhaust gas filter to carry a promoter. Therefore, Example 1 shows temperature increase performance equivalent or superior to that of the straight flow-type exhaust gas filter of Comparative Example 2 comprising cordierite.

In the present experimental example, an exhaust gas filter with the same plug part formation pattern as that of Embodiment 1 shown in FIGS. 2 and 3 was evaluated for oxygen storage capacity and temperature increase performance. Although a detailed explanation is omitted, it was confirmed that excellent oxygen storage capacity and temperature increase performance were also exhibited by an exhaust gas filter with the same plug part formation pattern as that of Embodiment 2 shown in FIGS. 5 and 6, and an exhaust gas filter with the same plug part formation pattern as that of Embodiment 3 shown in FIGS. 7 to 9.

### REFERENCE SIGNS LIST

1 . . . Exhaust gas filter
2 . . . Cell wall
20 . . . Pore
21 . . . Promoter
3 . . . Cell hole

1. An exhaust gas filter comprising:
a plurality of cell walls;
a plurality of cell holes surrounded by the cell walls; and
plug parts each sealing one of both ends of at least a part of the cell holes, wherein
the cell walls each have pores that allows adjacent cell holes to communicate with each other; and
the cell walls contain at least one promoter selected from a group consisting of ceria, zirconia, and a ceria-zirconia solid solution, as a constituent of the cell walls.

2. The exhaust gas filter according to claim 1, wherein
the cell walls are composed of a material containing a ceria-zirconia solid solution as a main component, and further containing θ alumina and an inorganic binder.

3. The exhaust gas filter according to claim 1, wherein
the plug parts contain the promoter as a constituent of the plug parts.

4. The exhaust gas filter according to claim 1, wherein
one of both ends of the cell holes is sealed with the plug part, and the plug parts alternately seal upstream ends of the adjacent cell holes facing exhaust gas flow, or downstream ends opposite to the upstream ends.

5. The exhaust gas filter according to claim 1, wherein
the cell holes are made up of open cell holes penetrating the exhaust gas filter in an axial direction, and plugged cell holes provided with the plug parts that close the upstream ends of the cell holes.

6. The exhaust gas filter according to claim 5, wherein
in a cross-section orthogonal to the axial direction of the exhaust gas filter, the plugged cell holes have a flow passage cross-sectional area larger than that of the open cell holes.

7. The exhaust gas filter according to claim 1, wherein
the cell holes are made up of cell holes with an octagonal inner peripheral shape, and cell holes with a square inner peripheral shape; the octagonal cell holes have a hydraulic diameter larger than that of the square cell holes; and the octagonal cell holes and the square cell holes are formed in an alternate arrangement.
